(19) United States
(12) Patent Application Publication
(10) Pub. No.: US 2006/0033628 A1
(43) Pub. Date: Feb. 16, 2006

(54) Steering wheel vapor collection and sensing system using a chemical element

(76) Inventor: Landon Duval, Huntington Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/917,694

(22) Filed: Aug. 12, 2004

(51) Int. Cl. G08B 23/00; G05D 1/00

(52) U.S. Cl. 340/576; 701/1

(57) ABSTRACT

A vapor sensitive material is configured for encircling a steering wheel. The material is held within a flexible cover over the steering wheel or is bonded directly to the steering wheel or is held against the steering wheel by the cover, or is placed within a groove in the steering wheel. The material forms one element of an electrical sensory circuit able of detecting ethyl alcohol vapor partial pressures in the breath or sweat of the hands of a person holding the steering wheel.

### RELATED APPLICATIONS

This application is related to a co-pending application entitled, “Steering Wheel Vapor Collection and Sensing System Using Suction,” which describes a related apparatus and method for detecting vapors in an automotive steering wheel structure, and which was filed on Jul. 26, 2004 as Ser. No. 10/899,826.

### INCORPORATION BY REFERENCE

Applicant hereby incorporates herein by reference, the U.S. patents and U.S. patent applications, described in the Description of Related Art section of this application; specifically by document number: 20030087452; 4,090,078; 4,277,251; 4,363,635; 4,649,027; 4,749,553; 4,849,180; 4,905,498; 5,055,268; 5,220,919; 5,376,555; 5,743,349; 6,075,444; 6,097,480; 6,183,418; 6620108.

### BACKGROUND OF THE INVENTION

1. Field of the Invention

This invention relates generally to vapor collection systems and especially to the detection of trace amounts of an alcohol containing substance carried by vapors, such as a person's breath, or vapor evaporation from skin surfaces. This invention is related to analyzers used by law enforcement agencies where the breath of a driver is subject to analysis; and more particularly to a steering wheel mounted structure for collection detection of such vapors as minute partial pressures.

2. Description of Related Art

The following art defines the present state of this field and each of these disclosures is hereby incorporated herein by reference:

Ratogi, et al. 20030087452, discloses is a method of making a bismuth molybdate precursor solution using a metallorganic decomposition (MOD) process consisting of the formation of a precursor sol of hexanoates of Bismuth (Bi) and Molybdenum (Mo). The precursor solution is used to make thin film of Bismuth molybdate by spin coating and spray pyrolysis. The bismuth molybdate films have the useful alpha and gamma phases having high sensitivity to ethanol gas, the detection of the ethanol gas is based upon the change of electrical conductivity of a thick film of the semiconductor oxide sensing element resulting from the ethanol gas in an oxygen-containing atmosphere. When the drying is effected by spray pyrolysis, quite thick films with high adhesion have been produced over different substrates, including quartz. The thin film of the present invention made by spray pyrolysis has a very fast response to ethanol detection eg typically 5 seconds.

Heim, U.S. Pat. No. 4,090,078 describes a method for determining the alcohol content in the exhaling respiratory air using an alcohol measuring instrument and measuring the alcohol content when the exhaling air transmits the determined value of the alcohol concentration. This determined value of alcohol concentration occurs when the time variation related to the height of the alcohol signal is below a predetermined threshold value and the velocity of flow of the exhaling air is above a given value and is maintained without interruption for a given time. The apparatus includes an infrared measuring instrument which is connected into the respiratory air current and measures the alcohol concentration of the exhaling air. This value is applied to an indicator through a linear gate when an AND-gate is triggered by threshold comparators and a timing element activated by a threshold comparator.

Leichnitz, U.S. Pat. No. 4,277,251 describes a method of determining the alcohol content of air exhaled by a person using a flow through testing tube having an alcohol indicating material therein and a sampling tube to which the air is directed which has a material therein for retaining the alcohol of the breathing air and also using a suction pump comprises cooling the sampling tube, passing the exhaled air through the cooled sampling tube, measuring a volume of the air passing through the cooled sampling tube, heating the sampling tube and connecting the suction pump to the sampling tube to suck flushing air through the heated tube and then through the testing tube. The sampling tube advantageously contains a silica gel to retain the alcohol therein. The volume measuring device may be a measuring bag.

Hutson, U.S. Pat. No. 4,363,635 describes a method and apparatus for discriminating between alcohol and acetone in a breath sample and accurately measuring the alcohol level when acetone is present in the sample. The breath sample is measured with two different types of detectors and their outputs compared. One detector uses the principles of infrared (IR) absorption, the other detector is a semiconductor, commonly called a Taguci cell, or its equivalent. Automatic correction is provided for variations in sensitivity of the semiconductor.

Talbot, U.S. Pat. No. 4,649,027 describes a battery-operated portable breath tester. The breath tester includes a housing which defines a sleeve for receiving a wand. The wand defines an internal sample chamber, with a lamp at one end for providing infrared energy and a detector at an opposite end for receiving the infrared energy after it has passed through the sample to be tested. The wand defines opening extending from the internal sample chamber to the outside of the wand. The wand has an external shape providing a snug fit within the sleeve. As the wand is moved within the sleeve, gas is purged from the wand. The wand is connected to the housing by means of an electrical coil. The housing encloses a digital voltmeter including a digital display for providing a test readout. The digital voltmeter includes an oscillator which is coupled through a frequency divider and a transistor switch to the lamp. The lamp is switched on and off in accordance with the frequency output of the frequency divider to modulate the infrared energy emitted from the lamp at a selected frequency. A voltage regulator is connected to the lamp, and the lamp and voltage regulator are located in heat-exchange relationship with the sample chamber. This aids in raising the temperature of the sample chamber during testing in order to alleviate condensation.

Lopez, U.S. Pat. No. 4,749,553 describes a breath alcohol detector measuring and compensating for distance between the mouth of the individual exhaling breath into the ambient air and the detector, the atmospheric pressure, and the temperature. Blood alcohol content information is calculated using these compensation factors and a signal obtained from an electrochemical fuel cell which is indicative of the amount of alcohol or other gas contained in the sample. The detector also includes a reciprocally acting electromagnetically energized motor which drives a diaphragm pump to draw the sample into the electrochemical fuel cell.

Fukui, U.S. Pat. No. 4,849,180 describes an alcohol selective gas sensor including a detecting electrode and a semiconductor detecting element in contact with the detecting electrode, the semiconductor detecting element comprising tin oxide (SnO₂) and a metal oxide of at least one of alkaline earth metals (Be, Mg, Ca, Sr, Ba) carried by the tin oxide, the metal oxide being contained in an amount of about 0.5 mol % or above.

O'Donnell et al., U.S. Pat. No. 4,905,498 describes a gaseous detection system for detecting the existence of a certain gas and further the detection of a certain level or percentage of that certain gas within a certain environment. An example is use of the gas detection system in a motor vehicle to aid in determining when a driver of the motor vehicle may be driving under the influence of alcohol, and for providing an appropriate warning signal that may be viewed from the exterior of the motor vehicle. The system includes a sensor unit for sensing ethanol in the atmospheric contents of the motor vehicle's interior, for example, a unit for providing an actuation signal in response to the sensing unit, and a signal unit that generates a signal which can be utilized for many purposes, for example, causing at least some of the exterior lights on the motor vehicle to alternately flash on and off in a substantially non-standard pattern. The sensing unit may also be coupled with a digital read-out device or the like to indicate the amount of blood alcohol content of a person for evidentiary or like purposes.

Martin, U.S. Pat. No. 5,055,268 describes an air-borne chemical sensor system including a motor and impeller to draw an air sample into a housing containing a sensor which will provide a signal for display related to the amount of a particular air-borne chemical in a given air sample. The system is controllable by different duration activation of a single activating switch which can further control a secondary function, such as a flashlight.

Phillips, U.S. Pat. No. 5,220,919 describes a gaseous detection system for detecting the existence of a certain gas and further the detection of a certain level or percentage of that certain gas within a certain environment. An example is use of the gas detection system in a motor vehicle to aid in determining when a driver of the motor vehicle may be driving under the influence of alcohol, and for providing an appropriate warning signal that may be viewed from the exterior of the motor vehicle. The system includes a sensor unit for sensing ethanol in the atmospheric contents of the motor vehicle's interior, for example, a unit for providing an actuation signal in response to the sensing unit, and a signal unit that generates a signal which can be utilized for many purposes, for example, causing at least some of the exterior lights on the motor vehicle to alternately flash on and off in a substantially non-standard pattern. The sensing unit may also be coupled with a digital read-out device or the like to indicate the amount of blood alcohol content of a person for evidentiary or like purposes.

Forrester et al., U.S. Pat. No. 5,376,555 describes a method and infrared sensing device for determining the concentration of alveolar alcohol in a breath sample exhaled by a subject into an infrared sensing device. The presence of alcohol from the upper respiratory tract of the subject is detected by continuously monitoring alcohol and carbon dioxide, normalizing alcohol values with respect to carbon dioxide, calculating a difference between normalized alcohol concentration and carbon dioxide concentration over time, integrating (summing) the difference, and comparing the integrated difference with a threshold. This technique accurately and consistently detects the presence of mouth alcohol in the sample before the presence of carbon dioxide which originates in deep lung breath.

Steinberg, U.S. Pat. No. 5,743,349 describes a vehicle ignition interlock system including a non-invasive reader of a person's blood-alcohol concentration in combination with ignition interlock circuitry that prevents operation of a vehicle by an intoxicated person. The non-invasive blood-alcohol concentration reader, termed alcoh-meter, utilizes optical spectroscopic electromagnetic radiation technology to determine the alcohol levels in the blood. The alcoh-meter is preferably a dash mounted sensor for receiving a person's finger and absorbing incident light from a multiple wavelength light source and causing a light absorption reading to be generated based on the person's blood alcohol concentration in the finger tissue. After registering a reading, the results are compared electronically against a table of impaired/non-impaired levels of blood alcohol concentration. The impaired/non-impaired results are communicated to interlock circuitry that either enables, or disables start-up of the vehicle. If an impaired status is determined, the results are displayed instructing the operator to wait, or find a non-impaired operator.

Soheege et al., U.S. Pat. No. 6,075,444 describes an arrangement for blocking the operation by an intoxicated operator of a machine or a motor vehicle. The arrangement has a measuring apparatus which determines the blood alcohol content of the operator and an evaluation unit connected to the machine or motor vehicle. The evaluation unit receives measurement data supplied by the measurement apparatus and enables the machine or motor vehicle when the measurement data satisfies at least one predetermined condition. The arrangement is improved in that the sobriety of the operator is recognized before the starting operation of the machine or motor vehicle without it being necessary to supply a breath sample. The measuring apparatus includes a gas sensor which is a sensor for measuring the blood alcohol content via permeation through the skin of the operator. The measuring apparatus is configured so that it can be worn by the operator preferably on the leg or arm.

Kaplan, U.S. Pat. No. 6,097,480 describes a vehicle interlock system which utilizes non-invasive, optically based methods for detecting and measuring levels of certain target chemical substances in the blood or tissues of a user in preventing operation of the vehicle by persons exhibiting higher (or lower) than prescribed levels of such chemicals. The system of the present invention is not limited to simply measuring blood alcohol levels as are presently available breathalizer-based interlock systems, but lends itself to use in detecting unacceptable systemic levels of virtually any chemical for which the system if programmed to measure. In addition, the present system includes components for positively identifying, and during the course of vehicle operation, re-identifying the intended user and alcohol or drug user testee.

Kuennecke, U.S. Pat. No. 6,183,418 describes the process for detection and for quantitative determination of substances emitted or perspired through the skin is derived from flow diffusion analysis. The measuring system conceived for this purpose uses a diffusion half cell through which an acceptor medium flows and which is closed by a membrane. For the duration of the measurement, the membrane is brought into contact with the skin or a closed gas volume formed over the skin. With the process and the related measuring system, the blood alcohol level can be determined with a good degree of precision indirectly via the quantity of (gaseous) ethanol emitted through the skin.

Duval, U.S. Pat. No. 6,620,108 describes an apparatus and method for assuring that a machine operator is not under the influence of a chemical, comprising a first sensor positioned proximally to the machine operator and adapted for measuring a vapor concentration proximal thereto, a second sensor positioned distally from the machine operator and adapted for measuring the vapor concentration distally from the operator, a device for comparing the proximal and distal vapor concentrations, and an automated remediating element responsive to the comparing device when the ratio of the first and the second vapor concentrations are within a specified range.

Our prior art search with abstracts described above primarily teaches the use of analyzing vapors produced in the exhalant of an individual. Thus, the prior art shows several solutions to the collection and analysis of minute partial pressures of vapors. However, the prior art fails to teach a simple system that can avoid the use of deliberate breath analysis and yet be inexpensive by avoiding the very high sensitivity required of room air analyzers. The present solution employs a steering wheel having an integral chemical element which is able to detect alcohol vapors from a users hands, i.e., excreted through the skin; analyze the vapors and produce a control signal. This enablement allows automatic monitoring and the initiation of remedial actions when necessary for the safety of the individual and the public at large. The present invention fulfills these needs and provides further related advantages as described in the following summary.

### SUMMARY OF THE INVENTION

Data has been collected on the number of accidents and accident related deaths on U.S. highways each year that are, at least in part, related to alcohol or other substances within the blood stream of drivers. This data shows that it would be wise to take steps to prevent motorists from driving when they are under the influence of such substances. One solution to this problem is to install a device in existing and new automobiles, and other types of vehicles that will monitor and possibly prevent such driving. The present invention teaches certain benefits in construction and use of such devices which give rise to the objectives described below and forms at least a partial solution to this problem.

The invention is a detection system installed onto or into a steering wheel of a vehicle wherein a chemical sensor is able to detect alcohol vapors emitted by the driver. Such vapors may be from the driver's breath, his or her clothing, or from the driver's hands as they touch and come into contact or merely just close proximity to a sensor element. It may be used on automobiles, trucks, buses, boats and other vehicles. Such detection may trigger a warning or other action, including shutting down the ignition system of the vehicle. In a best mode preferred embodiment of the present invention, a solid state vapor sensor is made an integral part of the steering wheel. In an alternate embodiment, the vapor sensor is part of a steering wheel cover and is adapted to be placed onto an existing steering wheel. The vapor sensor may be any one or more of the substances described in the cited prior art, and it may be coated, bonded or otherwise placed on the steering wheel or within one or more grooves in the steering wheel's exterior surface. The sensory element(s) may be part of a detection and alarm circuitry built into the steering wheel/steering column structures or may be connected to such circuitry by fine wire signal conductors or by wireless means. Such circuitry may be placed behind a control or dash board of the vehicle. Such a circuit may be enabled for controlling an ignition circuit of the vehicle. Alternately, the control circuit might control audible or visual devices to inform the driver that he/she is driving dangerously, or might control other devices as deemed necessary to protect the driver, any passengers and the general public.

A primary objective of the present invention is to provide an apparatus and method of use of such apparatus that yields advantages not taught by the prior art.

Another objective is to assure that an embodiment of the invention is capable of integrating vapor collection with a steering wheel assembly.

A further objective is to assure that the vapor is received by the steering wheel assembly.

A further objective is to assure that the vapor comes into contact with a vapor detector within the steering wheel assembly.

A still further objective is to assure that an electrical signal is generated or modified by the vapor detector so as to generate an alert signal.

Other features and advantages of the embodiments of the present invention will become apparent from the following more detailed description, taken in conjunction with the accompanying drawings, which illustrate, by way of example, the principles of several possible embodiments of the invention.

### BRIEF DESCRIPTION OF THE DRAWINGS

The accompanying drawings illustrate the best mode embodiments of the present invention.

In such drawings:

FIG. 1A is a perspective exploded view of the present invention wherein, in one embodiment, a chemical sensory element is placed within a steering wheel cover, an interior surface of the cover free to be bonded to a steering wheel;

FIG. 1B is an enlarged perspective view thereof;

Figure 1C is an enlarged perspective view similar to that of FIG. 1B, wherein the chemical sensory element provides an inner surface for bonding to the steering wheel and is covered exteriorly by the steering wheel cover which may be bonded or tied in place around the steering wheel and the sensory element;

FIG. 2 is a rear perspective view of a steering wheel and steering column structures showing electrical wiring of a retrofit version of the invention;.

FIG. 3A is a partial sectional view, taken along cutting plane line 3-3 in FIG. 2, showing placement of the sensory element of the invention within a groove in the steering wheel and internal electrical wires engaged therewith;

FIG. 3B is a partial sectional view, taken along cutting plane line 3-3 in FIG. 2, showing placement of the sensory element of the invention within a groove in the steering wheel and an internal a wave energy transmitter engaged therewith; and

FIG. 4 is a perspective view of the invention as installed in a vehicle.

### DETAILED DESCRIPTION OF THE INVENTION

The above described drawing figures illustrate the present invention in two of its preferred, best mode embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

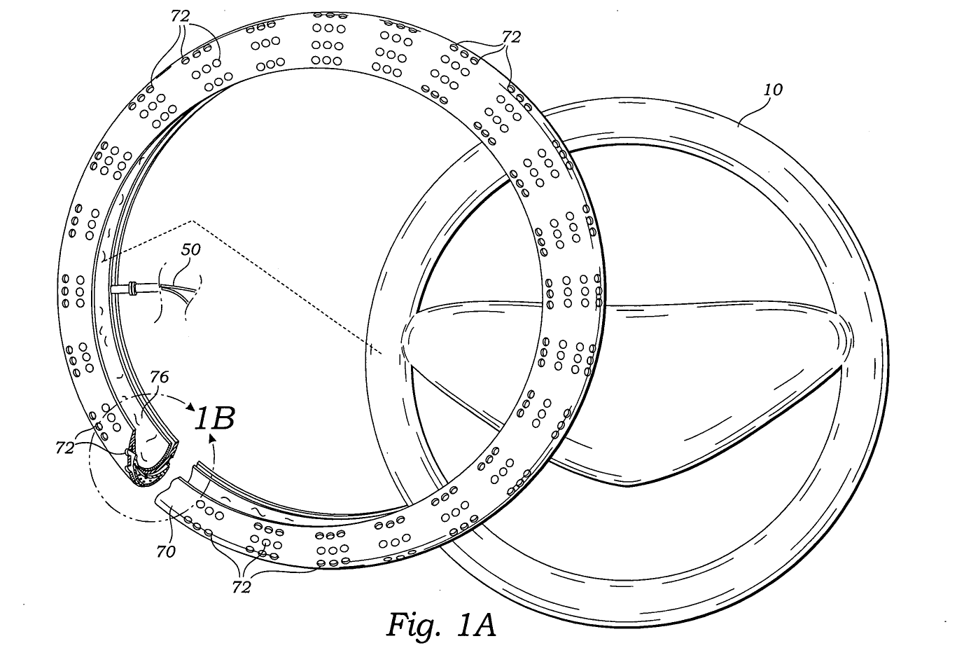

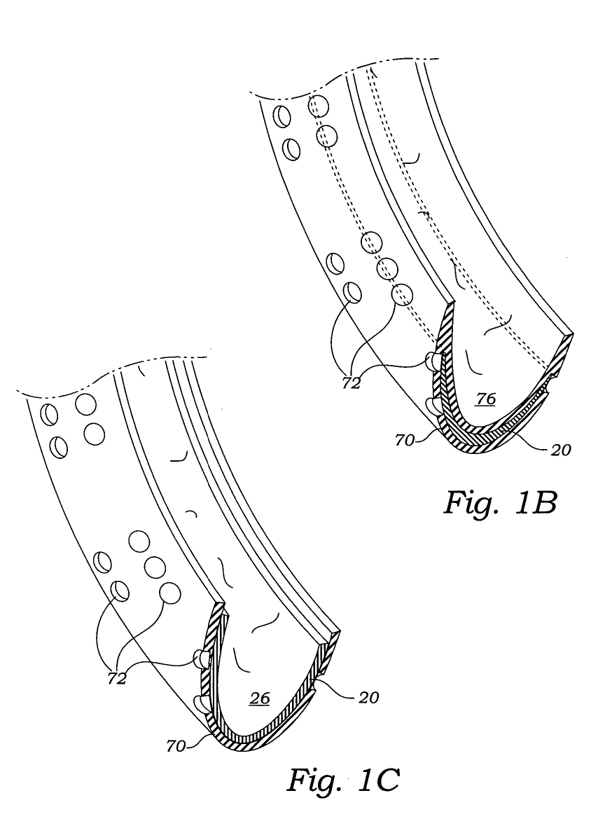

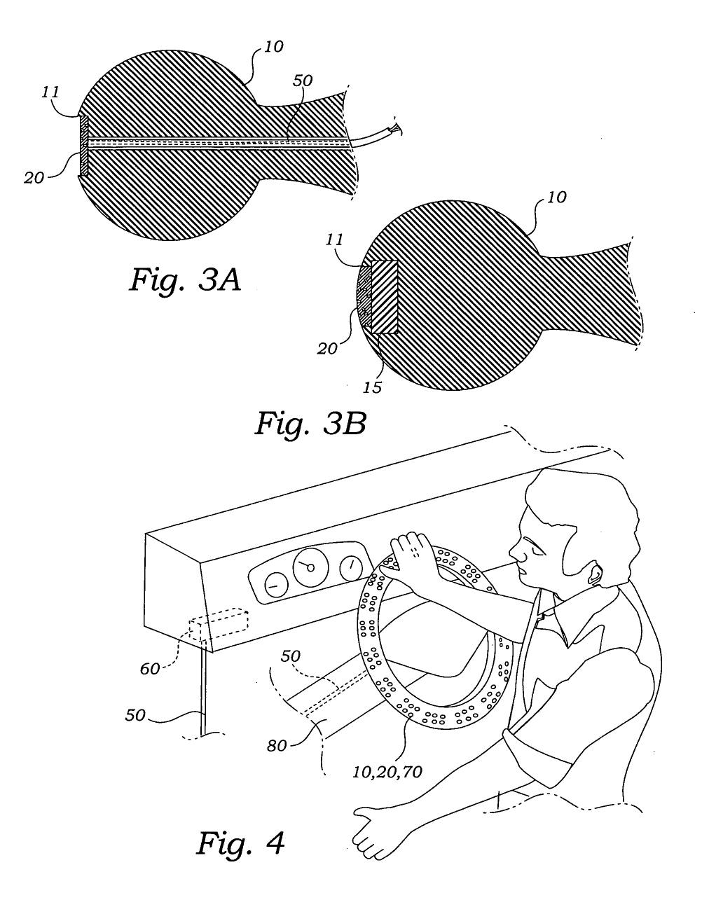

In one embodiment of the present invention shown in detail in Figs. 1A and 1B, a vapor sensory element 20, having sensitive specificity to ethyl alcohol, is placed within a steering wheel cover 70. Both the element 20 and the cover 70 are configured for encircling a steering wheel 10. The element 20 is shaped to correspond with the steering wheels surface conformation, as a generally crescent shape. The sensory element 20 is of an alcohol sensitive material as will be described below, or may be a mere coating of such material placed on a support. In the embodiment of Fig. 1B, the sensory element 20 is inserted into the steering wheel cover 70 and cover surface 76 is adhesively bonded to the steering wheel. In the embodiment of Fig. 1C, the sensory element 20 is merely covered by the steering wheel cover 70 so that surface 26 is placed into adhesive contact with steering wheel 10. In both cases, the cover 70 has plural apertures 72 which allow vapors to reach the element 20. When vapors are excreted from the hands of a person holding the steering wheel, vapors evolve and flow through the apertures 72 and contact the element 20. The vapors flow naturally without being drawn in any way to the sensor 20. Should the person holding the steering wheel 10 have alcohol in their blood stream, from alcoholic beverages for instance, vapors excreted by the hands will contain trace amounts of ethyl-alcohol. These vapors are detected by sensory element 20 which, then, produces an electric circuit effect and such effect enables a circuit 60 in the steering wheel itself, the steering wheel column 80, or elsewhere in the vehicle (FIG. 4) to product an alarm signal. Electrical conductors 50, such as copper wires, join the sensor element 20 with circuit 60 thereby establishing electrical signal communication therebetween for establishing control of an ignition circuit of the motor vehicle (not shown), or for setting off an alarm or for enabling other appropriate actions.

The cover 70 is preferably of an organic material such as rubber or leather, and may be permanently bonded to the steering wheel 10 or it may be removable as is well known in the art. As shown in FIGS. 1B and 1C, such a cover 70 may fully enclose the sensor element 20, or it may merely form an outer protective layer over the sensor material 20.

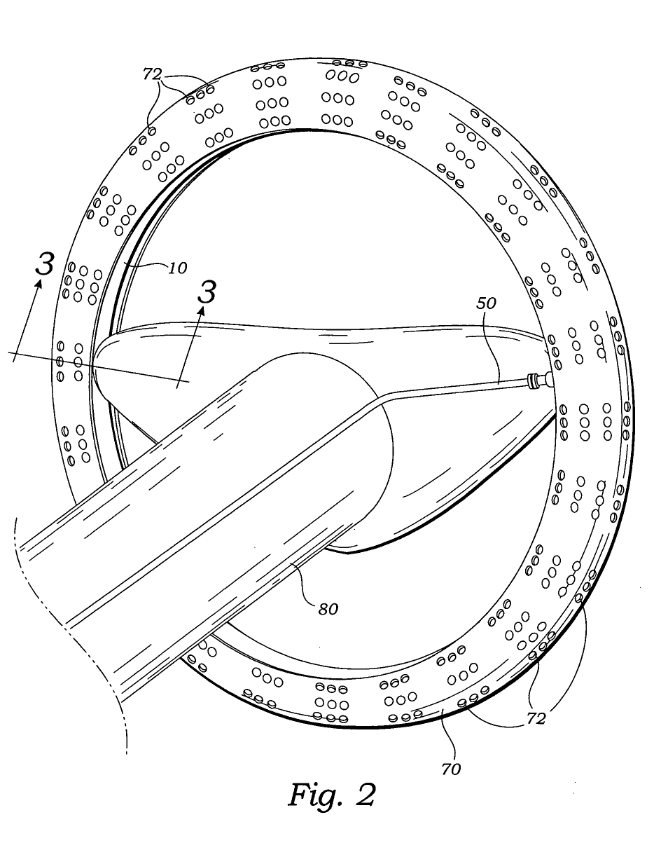

As shown in FIG. 4, the wires 50 may be routed from the sensor element 20 via the steering column 80, externally or internally, to the circuit 60 which is typically mounted within a dash board for a car, truck, boat or aircraft. The circuit 60 preferably provides means for triggering an alarm or other action depending upon the reaction of element 20 to the vapors. Such triggering or other circuit performance is well known in the art. Instead of using wires 50 to join element 20 with circuit 60, as shown in FIG. 3A, a wireless data communication method may be employed as is also well known in the art. Such a wireless method employs a transmitter element 15 mounted within the steering wheel 10, as shown in FIG. 3B.

In the alternate embodiments shown in FIGS. 3A and 3B, the steering wheel 10 is molded with one or more grooves 11 in its surface. The grooves 11 are fitted with the sensory element 20. In this embodiment, the element 20 may be of a type that requires physical contact with the skin of the driver, or at least very close proximity between skin and sensory element 20.

In operation the vapor sensitive material 20 may be tin oxide (SnO₂) and a metal oxide of at least one of the alkaline earth metals (Be, Mg, Ca, Sr, Ba) carried by the tin oxide, the metal oxide being contained in an amount of about 0.5 mol % per Fukui, or it may employ the gas sensor of Soheege et al. Also, the process of using a diffusion half-cell described by Kuennecke may be employed. In a still further alternate approach, as per Ratogi, et al. a bismuth molybdate precursor solution may be employed. In each case, the materials for sensing low levels of ethyl alcohol are well known in the art and are included by reference herein.

The enablements described in detail above are considered novel over the prior art of record and are considered critical to the operation of at least one aspect of one best mode embodiment of the instant invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of the embodiments of the herein described invention and its related embodiments not described are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A vapor sensing steering wheel apparatus comprising: a vapor sensory element encircling at least a portion of a steering wheel, the element conforming to the shape of the steering wheel for nesting therearound; the element held in place on the steering wheel by a cover having apertures positioned for admitting vapors from a driver's breath and hands to the sensory element; the element forming part of a sensing and alarm circuit so as to detect the presence of ethyl alcohol as a partial pressure within the vapors; for establishing safe control of a motor vehicle.

2. The apparatus of claim 1 wherein the sensory element is fully enclosed within the cover, an inner panel of the cover bonded to the steering wheel.

3. The apparatus of claim 1 wherein the sensory element is nested against and bonded to the steering wheel.

4. A vapor collecting and analyzing apparatus for use in a motor vehicle, the apparatus comprising: a vapor sensitive element engaged within at least one annular groove of a steering wheel; electrical conductors joining the vapor sensitive material with a sensing and control circuit for electrical signal communication therebetween for establishing control of an ignition circuit of the motor vehicle.

5. The apparatus of claim 4 wherein the vapor sensitive element provides an outer surface consistence with an exterior surface of the steering wheel.

6. The apparatus of claim 4 further providing a cover of organic material, the cover encircling and covering the steering wheel and the vapor sensitive element; the cover providing plural through-apertures for admitting vapors to the vapor sensitive element.
